(19) United States
(12) Patent Application Publication
(10) Pub. No.: US 2023/0182886 A1
(43) Pub. Date: Jun. 15, 2023

(54) LAND AND AIR VEHICLE

(71) Applicant: LANG AEROSPACE LLC, Dallas, TX (US)

(72) Inventor: DARREN GREGORY LANG, DALLAS, TX (US)

(21) Appl. No.: 18/064,900

(22) Filed: Dec. 12, 2022

Related U.S. Application Data
(60) Provisional application No. 63/288,415, filed on Dec. 10, 2021.
(60) Provisional application No. 63/297,400, filed on Jan. 7, 2022.

(51) Int. Cl. B64C 3/56; B64C 25/34; B64C 25/42; B64D 47/06

(52) U.S. Cl. CPC B64C 3/56; B64C 25/34; B64C 25/426; B64D 47/06; B64C 11/00

(57) ABSTRACT

An aircraft includes a fuselage with one or more wings coupled thereto. One or more wheels are also coupled to the fuselage and are configured to allow the aircraft to taxi, take off, and land. A propulsor is used to provide thrust to the fuselage and airflow over the wings. The wings may be fixed in position or may be configured to fold along a line via a hinged system or pivot along an axis. The folding allows the wings to store in a smaller footprint. The fuselage may include one or more safety features. These may include indicator lights configured to illuminate or reflect an amount of light. Additionally, the aircraft may include an occupant safety system with the likes of an airbag and even an anti-lock brake system coupled to the one or more wheels.

### CROSS REFERENCE TO RELATED APPLICATIONS

This application claims the benefit of an earlier filing date and right of priority to U.S. Provisional Application No. 63288415, filed 10 Dec. 2021, and U.S. Provisional Application No. 63297400, filed 7 Jan. 2022, the contents of which is incorporated by reference herein in its entirety.

### BACKGROUND OF THE INVENTION

### 1. Field of the Invention

The present application relates to a vehicle for land and air transportation.

### 2. Description of Related Art

The present disclosure pertains to a vehicle that can be driven on land and flown in the air as a fixed wing aircraft with improved short takeoff and landing (STOL) performance. Vehicles with land and air capabilities provide the ability for the vehicle to arrive quickly to a destination, or to reach a destination that would otherwise require multiple vehicles to travel to, such as separate land or air or water vehicles. Previous attempts at vehicles with both land and air capabilities have been attempted using a traditional fixed wing, non-STOL design; these vehicles require longer runways to takeoff and land from than an air vehicle with improved STOL capabilities, and thus require greater ground infrastructure and cost to support vehicle operations. Although strides have been made, shortcomings remain.

### BRIEF SUMMARY OF THE INVENTION

It is an object of the present application to provide an aircraft configured to include a fuselage with one or more wings coupled thereto. One or more wheels are also coupled to the fuselage and are configured to allow the aircraft to taxi, take off, and land. A propulsor is used to provide thrust to the fuselage and airflow over the wings.

It is a further object of the present application that the wings may be fixed in position. It is also configured to permit foldable wings that can fold along a line via a hinged system or pivot along an axis. The folding allows the wings to store in a smaller footprint.

Another object is to include safety functions into the fuselage. These may include indicator lights configured to illuminate or reflect an amount of light. Additionally, the aircraft includes occupant safety system with the likes of an airbag and even anti-lock brake system coupled to the one or more wheels, such as the drive wheel. These features may be included in any configuration or combination.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a land and air vehicle according to an embodiment of the present application.

FIG. 2 is a perspective view of an alternate embodiment of the land and air vehicle of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

The vehicle of the present application may be represented in one or more embodiments. One embodiment of the invention comprises a land air and air vehicle which includes the following key components; (a) a fuselage, (b) a wing, (c) one or more driven propulsors on one or more wings; and (d) a component necessary for land/road operations. With respect to the propulsors, the propulsors are ideally located such that the airstream generated by the propulsors flows around the wing. The interaction between the propulsors and the wing is what provides the STOL capability. This means the propulsors are typically forward of the wing. Any number of physical arrangements of the propulsors in relationship to the wing are possible, including any portion of the propulsor “in front of”, “above”, “beneath”, “behind”, or even “inside” a portion of the wing so as to satisfy the design goal of causing an airstream generated by the propulsors to flow over/across the wing. The component for land use may be that of a “wheel” although this is not meant to be limiting as many other types of components may be used in varying quantities and locations relative to the fuselage body of the vehicle. The (a) fuselage, (b) wing, (c) propulsors, and the airstream generated by the propulsors over the wing interact to provide the vehicle with improved STOL capabilities. A (d) driven wheel is necessary to give the vehicle land/road capabilities.

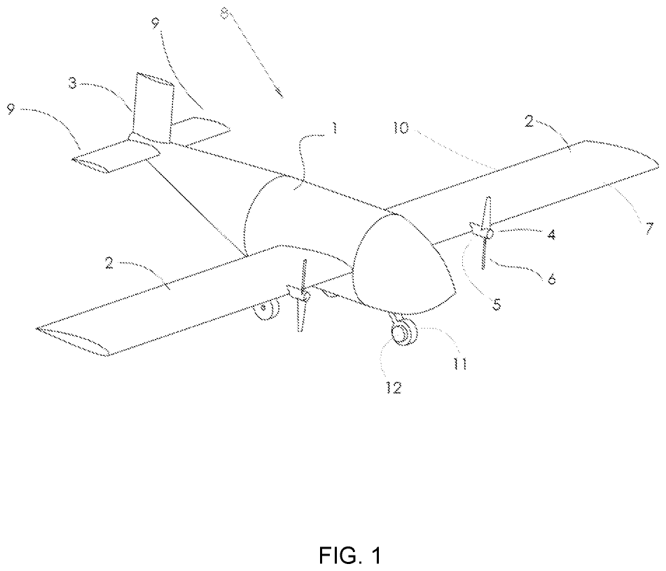

Referring now to FIG. 1 in the drawings, a perspective view of a land and air vehicle 8 is illustrated. Vehicle 8 includes a fuselage 1, one or more wings 2 extending outwards from the fuselage 1, an empennage located at an aft end of the fuselage 1, at least one propulsor 4 in communication with wing 2, and at least one wheel 11. The empennage comprises, but is not limited to, a vertical tailplane 3 and horizontal tailplane 9. Each wing 2 comprises a leading edge 7 and a trailing edge 10.

It is understood that the propulsor 4 is configured to attach to a portion of wing 2 and to induce a flow of air over a portion of wing 2. Propulsor 4 provides thrust used to drive the vehicle 8 forward whether in the air or perhaps partially on the ground.

Furthermore, wheel 11 may be a drive wheel wherein it may be coupled to a power unit (i.e. motor) of some type to induce and/or restrict motion on the ground separate from that of propulsor 4. If more than one wheel 11 is used, all or less than all wheels 11 may be a drive wheel. Any number drive wheels may be powered via one or more power units. In some embodiments some of the wheels will be “driveless” so as to freely rotate as a result of induced motion to vehicle 8. It is understood that in one embodiment the propulsor 4 may communicate with the power unit such that a single “motor” may induce both land movement and air movement.

In FIG. 1, propulsor 4 comprises a motor (not shown) housed within a nacelle 5, and further includes a propeller 6 driven by such motor. The motor and nacelle may be similar in form and function to other known aircraft, however, other forms of propulsors 4 may be a driven ducted fan, or a propeller being driven mechanically by a transmission wherein the transmission is being driven by a motor. The motor is not restricted to any particular type and given advancements in electric motors, the motor for propulsor may even include an electric motor. Propulsor 4 is not meant to be limited to any particular style or technology mentioned but such discussion serves only to provide exemplary methods which may be used with a propulsor 4 and illustrate the breadth of coverage in technology. For example, each propulsor 4 may be configured to include individual and/or shared driveshafts between each propulsor 4 to allow for the driving of the propellers/fans from a common shaft, chain, or pulley. In other words, each propulsor 4 may be fully independent in terms of power generation and operation from any other propulsor 4 or alternatively any number may be configured to share a portion of the power generation and operational means where either some or all the propellers or fans may be driven by a common component, such as a transmission for example. Shared power generation could have the benefit of synchronized performance between the propulsors 4, such as with the rotational speed of each propeller or fan.

In one embodiment each propeller 6 is located forward of the leading edge 7 of the wing 2 and is mounted to the wing 2 by the nacelle 5. Though other forms of propeller location (not shown) such as but not limited to, inside the wing 2, behind the wing 2, under the wing 2, or on top of the wing 2 could be employed. In use, the propellers 6 selectively rotate to provide airflow, and therefore thrust. Due to the location and arrangement of the propellers 6 relative to the wing 2, the airflow from propellers 6 travels over some portion of the wing 2. This airflow increases the effective airflow over the wing 2. This also increases the effective coefficient of lift (CL) when the propellers 6 are turning. Consequently, the propulsors 4 substantially increase the amount of lift generated by the wings 2 which helps to allow a reduction in the wing area required for a given amount of lift or increasing the amount of lift for a given wing area. This propulsor and wing interaction provides improved STOL capabilities for the vehicle while operating in air mode.

Wheel 11 is coupled to the fuselage 1 through customary or traditional methods such as struts, gearing, in communication with the wing and/or a portion of the fuselage 1. Wherein wheel 11 is a drive wheel, it may be driven by a motor 12. Motor 12 may be located in direct contact with wheel 11, such as in a hub assembly, or may be in communication through one or more gearing assembly distal from the wheel 11. This may be seen through driving mechanically by a driveshaft, chain, or pulley for example.

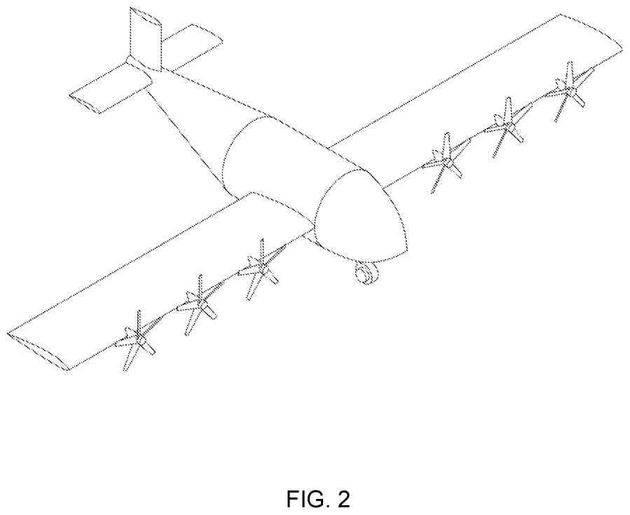

Referring now also to FIG. 2 in the drawings, an alternative embodiment of vehicle 8 is provided. The vehicle of FIG. 2 is similar in form and function to that of vehicle 8 in FIG. 1. In FIG. 2, the land and air vehicle is shown to include a multitude of propulsors on each side of the fuselage. This serves merely as an exemplary embodiment wherein multiple propulsors are used as opposed to that seen in FIG. 1.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. An aircraft, comprising:
a fuselage;
one or more wings coupled to the fuselage;
one or more driven propulsors in communication with the one or more wings and located such that an airstream generated by the propulsors flows over the one or more wings; and
at least three wheels in communication with the fuselage, wherein at least one of the three wheels is a drive wheel.

2. The aircraft of claim 1, further comprising:
an Anti-lock brake system in communication with at least one of the three wheels.

3. The aircraft of claim 1, wherein the one or more wings are configured to be foldable or pivotable for ease of storage and transportation.

4. The aircraft of claim 1, further comprising:
an airbag protect device within a portion of the fuselage configured to provide occupant protection.

5. The aircraft of claim 1, wherein the fuselage includes at least one indicator light.

6. An aircraft, comprising:
a fuselage configured to hold one or more passengers, the fuselage including an occupant safety system using at lease one of an airbag and anti-lock brake system;
one or more wings coupled to the fuselage;
one or more driven propulsors in communication with the one or more wings and located such that an airstream generated by the propulsors flows over the one or more wings;
at least three wheels in communication with the fuselage, wherein at least one of the three wheels is a drive wheel.

7. The aircraft of claim 6, wherein the anti-lock brake system is in communication with at least one of the three wheels.

8. The aircraft of claim 6, wherein the anti-lock brake system is in communication with the drive wheel.

9. The aircraft of claim 6, wherein the one or more wings are configured to be foldable or pivotable for ease of storage and transportation.

10. The aircraft of claim 6, wherein the airbag is located within a portion of the fuselage and is configured to provide occupant protection.

11. The aircraft of claim 6, wherein the fuselage includes at least one indicator light.
